(19) United States
(12) Patent Application Publication
(10) Pub. No.: US 2016/0065625 A1
(43) Pub. Date: Mar. 3, 2016

(54) Notification of Change in Online Conferencing

(71) Applicant: Cisco Technology, Inc., San Jose, CA (US)

(72) Inventors: Hua Ouyang, Suzhou (CN); Huahua Yin, Suzhou (CN); Qi Shi, Suzhou (CN); Yunwei Luo, Suzhou (CN)

(21) Appl. No.: 14/468,920

(22) Filed: Aug. 26, 2014

(51) Int. Cl. H04L 29/06; G06F 3/0484

(52) U.S. Cl. CPC H04L 65/403; G06F 3/04847; G06F 3/04842

(57) ABSTRACT

In one embodiment, an attendee of an online conference is notified of hidden changes to shared content of the online conference. When an attendee changes their focus, as indicated by minimizing, covering, or otherwise obstructing shared content of an online conference, the conference is monitored for changes. If an event or change is detected in the online conference, the attendee is informed of the event and/or shown the change. In addition or as an alternative to event detection, a thumbnail image of the shared content is created so that the attendee can monitor for changes.

### TECHNICAL FIELD

This disclosure relates in general to the field of computer networks and, more particularly, to online conferencing with improved user experience.

### BACKGROUND

In online conferencing, an attendee may shift their focus from the shared content of the conference to another program. The active window may be switched from the meeting window to an overlaying email or other window. To determine if the shared content of the conference has changed, the attendee re-activates the window of the conference. This may be repeated during the conference, resulting in a poor user experience. If the presenter asks a question of the attendee, the delay while the attendee activates the appropriate window is undesired. Another option is to shrink or reduce the window size so that multiple windows may be viewed. Even with this inconvenient arrangement, the windows may overlap, causing the attendee to miss changes in the shared content due to obstruction by another window.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts.

FIG. 1 is a simplified block diagram of an example network for notification of change in online conferencing;

FIG. 2 is a flow chart diagram of one embodiment of a method for notification of change in online conferencing;

FIG. 3 illustrates an example of a screen display with a window partially obstructing shared content;

FIGS. 4 and 5 illustrate example thumbnails displays;

FIG. 6 is a flow chart or communications chart of one embodiment for altering resolution for a thumbnail display;

FIG. 7 illustrates an example magnification from a thumbnail display;

FIG. 8 is a flow chart or communications chart of one embodiment for altering resolution for magnification from a thumbnail display; and

FIG. 9 is a block diagram of an online conferencing device, according to one embodiment, for notification of change in online conferencing.

### DESCRIPTION OF EXAMPLE EMBODIMENTS

### Overview

When an attendee of an online conference changes their focus, as indicated by minimizing, covering, or otherwise obstructing shared content of an online conference, the conference is monitored for changes. If an event or change is detected in the online conference, the attendee is informed of the event and/or shown the change. In addition or as an alternative to event detection, a thumbnail image of the shared content is created so that the attendee can monitor for changes.

In one aspect, a method is provided. Content from a screen of a presenter in an online conference is presented on a screen of an attendee. A computer of the attendee determines that the content on the screen of the attendee is inactive or at least partially not viewable. An event in the online conference is detected. The computer notifies the attendee in response to the detecting of the event where the content is determined to be inactive or at least partially not viewable.

In another aspect, logic is encoded in one or more non-transitory computer-readable media that includes code for execution. When executed by a processor, the logic is operable to perform operations including: recognizing a change in shared content of an online meeting where an attendee's active application is other than the online meeting; and indicating the change by a display to the attendee.

In yet another aspect, an arrangement is provided. An interface is configured to receive a video stream at lower and higher resolutions as part of an online meeting. A processor is configured to request and receive the video stream at the lower resolution in response to a user activating a program different than the online meeting or minimizing the online meeting. A display is configured to display video from the video stream at the lower resolution in response to the user activating the program different than the online meeting.

### Example Embodiments

A recognition mechanism lets an attendee of an online meeting easily recognize that the current sharing content is changed, even when the attendee is focusing on another work window. There are many special events in an online meeting, such as another attendee joining, a POWER POINT slide switching, and so on. These events are very important for host and attendee. The recognition mechanism detects these kinds of events and performs further actions based on detecting the events. Once an event is fired, the attendee may easily recognize this event. Thus, the attendee may decide to check or view the current sharing content in the online meeting or not in response to the notification. In one approach, upon receiving a change notification, the attendee is able to view current sharing content without manually switching to the online meeting window.

In one example embodiment, the meeting host shares a same slide for a long time. When the slide is changed, the change is recognized. In response, the attendee is notified by a thumbnail display of the new content. The thumbnail is displayed for a limited time to avoid disturbing the attendee where the attendee is working with another program.

In another example embodiment, the host shares their desktop or application in a video stream. Because the sharing is of the video stream, bandwidth usage may be reduced by altering the quality or resolution as appropriate. Where the attendee's focus is not on the online meeting (e.g., minimized meeting window), a lower resolution thumbnail of the video is shown. Otherwise, full quality or resolution is used. The video at the appropriate resolution is dynamically shared by the meeting server. The recognition mechanism may be used to initially trigger display of the thumbnail.

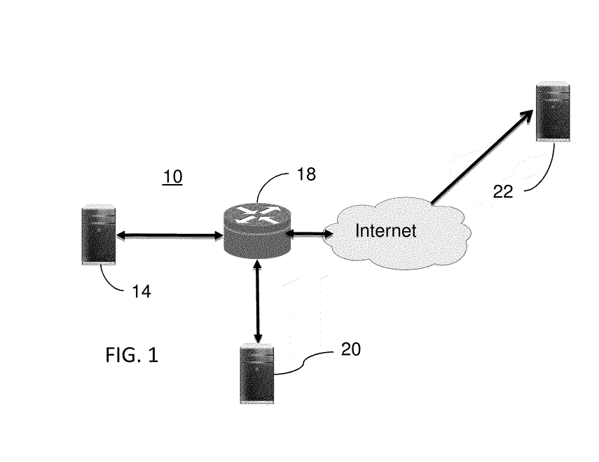

FIG. 1 shows an example network 10 for online conferencing. A media session between end-point devices 14, 20 and 22 or peers is created. Any number of end-point devices 14, 20, and 22 may be used, such as just two. The online conference is hosted by the network 10 for providing audio, video, and/or synthetic content between the end-point devices 14, 20, and 22. For video conferencing, the online conferencing server 18 may combine decoded inputs from different end-point devices 14 and 20 for encoding a combined video stream. For video or other online conferencing, the online conferencing server 18 may provide shared content from a presenter. In one embodiment, the network 10 supports operation of a telepresence or WebEx system from Cisco, but other online conferencing may be provided.

Additional, different, or fewer components may be provided in the network 10. For example, additional or fewer end-point devices to participate in a given media session, additional third-party servers, or different networks are provided. As another example, the online conferencing server 18 is not provided, with an end-point device 14, 20, 22 instead hosting and managing the video conference. In other examples, the network 10 may be many different devices connected in a local area network, wide area network, intranet, virtual local area network, the Internet, or combinations of networks. Any form of network may be provided, such as transport networks, data center, or other wired or wireless network. The network 10 may be applicable across platforms, extensible, and/or adaptive to specific platform and/or technology requirements.

The network devices (e.g., end-point devices 14 and 20) of the network 10 are in a same room, building, facility or campus, such as part of a same enterprise network. In other embodiments, the network 10 is formed with devices distributed throughout a region, such as in multiple states and/or countries. The end-point devices 14, 20, 22 may be in different networks.

The network devices are connected over links through ports. Any number of ports and links may be used. The ports and links may use the same or different media for communications. Wireless, wired, Ethernet, digital subscriber lines (DSL), telephone lines, T1 lines, T3 lines, satellite, fiber optics, cable, cellular, and/or other links may be used. Corresponding interfaces are provided as the ports.

The online conferencing server 18 is a server for managing or controlling the conference. The online conferencing server 18 receives any inputs, such as audio, video, and/or user inputs, from the various end-point devices 14, 20, 22 (e.g., from a presenter or host), determines information to output as part of the conference from the inputs, and transmits shared content (e.g., synthetic, audio, and/or video) to the end-point devices 14, 20, 22. In one embodiment, the online conferencing server 18 is a decoder and an encoder for receiving encoded inputs from the end-point devices 14 and 20, decoding the inputs, assembling video (e.g., combining input videos) and encoding the assembled video for output to any or all of the end-point devices 14, 20, and/or 22. The online conferencing server 18 is an application specific integrated circuit, a computer, a conferencing server, or other hardware. Any now known or later developed conferencing server or host may be used.

Any number of end-point devices 14, 20, 22 may be provided. The end-point devices 14, 20, 22 are computers, conferencing servers, tablets, cellular phones, Wi-Fi capable devices, laptops, mainframes, voice-over-Internet phones, or other user devices participating in a media session. The end-point devices 14, 20, 22 connect with wires, such as Ethernet cables, or wirelessly, such as with Wi-Fi. The connection may be relatively fixed, such as for personal computers connected by wires to switches. The connection may be temporary, such as associated with mobile devices. The end-point devices 14, 20, 22 may include encoders and/or decoders.

The end-point devices 14, 20, 22 may include one or more user input devices. For example, a mouse and keyboard are provided. As another example, a touch screen is provided. The end-point devices 14, 20, 22 include a microphone or speaker that may act as a microphone. One or more of the end-point devices 14, 20, 22 may include a camera. A microphone and speaker allow for audio communications as part of the video or online conference. A camera and display allow for video of the presenter and/or attendees as part of the video or online conference. Video may not be provided in other embodiments. The displays of the end-point devices 14, 20, 22 allow for display of shared content, such as display of the desktop or conference window of a presenter. For example, a document or application is displayed as shared content on the displays of the end-point devices 20 and 22 where the shared content is hosted or originates from the end-point device 14.

A processor, computer, server, memory, or other device creates and/or captures synthetic data at one or more end-point devices 14, 20, 22. For example, a personal computer or conferencing server generates a POWER POINT or other presentation using software or a program. The synthetic content may be captured in real-time. Alternatively, the synthetic content is captured only upon a trigger, such as a change in the display.

The end-point devices 14, 20, 22 are configured to initiate or participate in a media session. The end-point devices 14, 20, 22 operate pursuant to a real-time protocol (RTP) or other communications protocol for video and/or audio communications with data sharing. As part of the media session, content from another source may be added or incorporated. For example, data from one or more authorized sources, such as a financial services server, search engine, drop box database, or other source, is to be included in the media session. The web content is requested pursuant to TCP/IP or other protocol. The presenter controls the shared content.

The end-point devices 14, 20, 22 display the content for the online conference in a window or other designator (tab) of a region on the screen. Other programs available to or resident on the end-point devices 14, 20, 22 may be used by the attendee. While the attendee is using or interacting with one program (i.e., active program), the other programs may be inactive. Inactive programs may be minimized, partially covered, or entirely covered as displayed on the screen of the attendee. For example, the window or output of the online conference is partially covered while the attendee actives or brings to the front a word processing, browser, email, texting, or other program.

The various components of the network 10 are configured by hardware and/or software to operate for online conferencing. Logic is provided in one or more non-transitory computer-readable media for operating the end-point device 14, end-point device 20, end-point device 22, and/or conferencing server 18. The media is a memory. Memories within or outside the network 10 may be used. The logic includes code for execution by a processor or processors, such as processors of the end-point devices 14, 20, 22 or conferencing server 18. When executed by a processor, the code is used to perform operations for notifying an attendee of change to hidden shared content of an online conference.

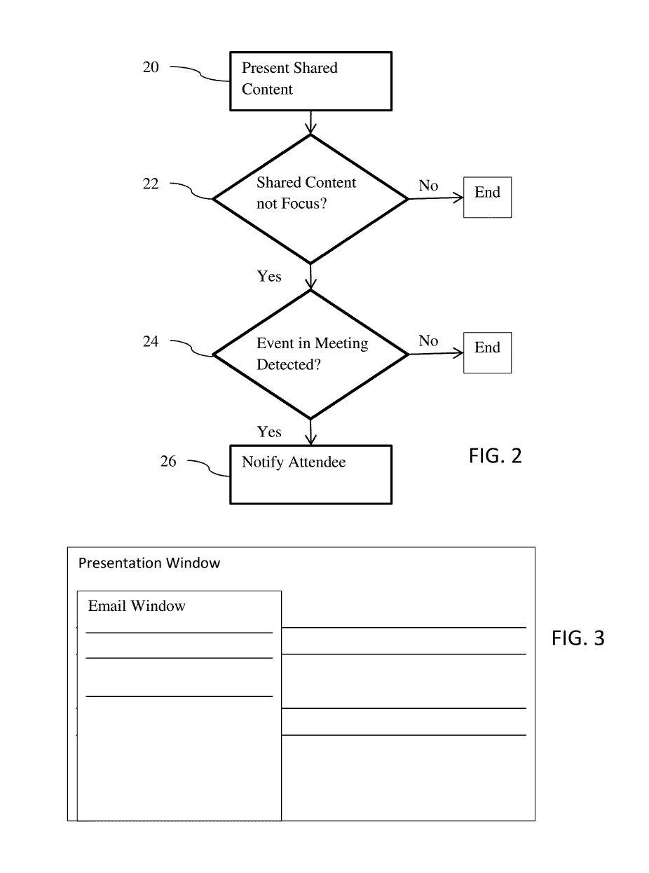

FIG. 2 shows a method for notification of change in online conferencing. The online conferencing includes display of shared content. Video of the presenter and/or attendee may or may not be provided. In one embodiment, the online conference is a WebEx conference. In another embodiment, the online conference is a telepresence conference. Other online conferencing applications or programs may be used. Some or all of the shared content may become hidden due to the attendee interacting with other programs.

Various acts are shown in FIG. 2. Additional, different, or fewer acts may be performed. For example, act 20 is not performed as the attendee begins the online conference with the content covered.

The acts are performed in the order shown (e.g., top to bottom or numerically). In other embodiments, other orders are provided, such as event detection in act 24 prior to checking for focus of the attendee on a program other than the online conference in act 22.

The acts are performed by the attendee computer 14 without interaction from the conferencing server 18. Image processing or receipt of information is used by the attendee computer 14 to determine attendee focus in act 22 and/or to detect an event in act 24. The attendee computer 14 then notifies the attendee in act 26. Some interaction may be provided, such as the attendee computer 14 requesting and/or receiving shared content for the online conference from the conferencing server 18 in act 20. Other interaction may be the conferencing server 18 detecting an event in act 24 and/or providing information used by the attendee computer to detect the event in act 24.

The same acts may or may not be performed independently for other attendee computers. Depending on the focus of the other attendees, detection and notification may or may not be provided in the other attendee computers.

Shared content is transmitted from the conferencing server. The shared content is a document, presentation, application, video, or other information. For example, the shared content is a POWER POINT presentation, a table of a spreadsheet, a document, a .pdf, a web site, a picture, a video, and/or an application. The shared content may be from a local memory or downloaded from a remote source. In one embodiment, the shared content is a single window of information or multiple windows of information, such as any windows or delineated data in an online conference window. In another embodiment, the shared content is an entire desktop.

The shared content is from a presenter. The presenter selects the shared content, and the online conferencing application provides the shared content to the conferencing server 18 for distribution to attendees. In other embodiments, one of the attendees provides the shared content, such as through permission or prior arrangement by the presenter and/or presenter's computer. Regardless of the source, the conferencing server 18 (or source computer) transmits the shared content to other attendees.

In act 20, the attendee computer 14 presents the shared content on a screen. The shared content on the presenter's screen is also presented on the screen of the attendee computer 14 and the screens of any other attendees. The desktop, application, or other shared content is shared with the participants of the online conference. For example, the presentation of the shared content from the computer of the presenter on the screen of the attendee allows both the presenter and the attendee to view the same content. In another example, a multi-page document or multi-slide presentation is presented. Only part (e.g., a page of the document or one slide) of the document or presentation is displayed at any given time.

The shared content is displayed to the attendee. On the screen of the attendee's computer 14, only the shared content or the shared content and other information is displayed. For example, FIG. 2 shows two windows on a display of a personal computer of an attendee. The larger or maximized window is for an online presentation. The online line presentation window is inactive in this case as the attendee has activated the other window, an email window. The other window in this example is an email window, but may be a word processing window, folder, web browser, or other program. The window on top of the screen (i.e., the window covering any windows in the same region of the screen) is the active window.

Window is used to express a designation of a region or deliminator of information for a given program. In other embodiments, other designators than rectangular boxes as windows are used. Tabs in a browser or operating system may be used. By selecting a tab, a region of the screen is dedicated to the program or content for that tab. The program or content for other tabs is covered or partially covered.

In an alternative to covering a window due to active and inactive status of the various programs, one or more programs may be minimized to become inactive. The program is reduced to an icon or other representation while not active. The user interface for any active program is displayed for the user to interact with the program. The user interface for an inactive program is not displayed or is not operable without first activating the program.

During the online conference, the shared content of the presenter or another attendee continues to be displayed to the attendee by the computer of the attendee. The attendee may interact with the computer of the attendee, changing the focus away from the shared content. The attendee computer may determine this change in focus of the attendee based on which windows, tabs, or other information are active and which are not, which programs are minimized and which are not, which information is displayed and which is not, whether content is blocked, and/or other indicators.

In act 22, the computer of the attendee determines that the shared content of the online conference on the screen of the attendee is inactive or at least partially not viewable. Being inactive or partially covered indicates that the attendee is focused on other information or another program. In one embodiment, information from the operating system indicating that the window or shared content of the online conference is minimized (e.g., reduced to an icon) or inactive indicates a focus not on the conference. In another embodiment, another program being active indicates focus away from the online conference. The shared content may be entirely viewable, but inactive to show no or less focus.

In another embodiment, the computer of the attendee determines that a window for displaying the shared content or other shared content of the online conference is covered by a window or content of another application. Any amount of coverage may be provided. In the example of FIG. 3, the email window covers about 30% of the area of the window of the online conference. The amount of covering to indicate a different focus may be predetermined, such as 5%, 25%, 50%, or other number. The number is set by the user or preprogrammed by an administrator or programmer (e.g., default amount). Due to the overlap or covering, the shared content may not be entirely viewable to the attendee on the screen of the computer of the attendee. If the threshold amount is covered, then the attendee is determined to have another focus. In other examples, other active and/or inactive content entirely covers the shared content or all of the area of the display for the online conference.

The computer determines the area or amount of blockage using image processing. Alternatively, information from the operating system is used to indicate the amount of blockage or that there is some blockage.

During the online conference, different events may occur. In act 24, the computer of the attendee detects the event in the online conference. The event is detected by image processing. For example, a part of the shared content or online conference window is analyzed to detect an event. Different parts are analyzed to detect different events. Alternatively, information provided by the program executing the online conference on the computer of the attendee is looked up or acquired to detect the event. In other embodiments, the event is detected by receiving a notice or information about a change from another source, such as the conferencing server or computer of the presenter indicating a change in a message. For audio, the detection may use pattern matching, voice recognition, or other audio detection.

The detection recognizes a change in shared content or other aspect of an online meeting. In one example process, the detection is performed only once the focus is determined to be away from the online conference in act 22. The detection is for where an attendee's active application is other than the online meeting and/or where the online conference is at least partially covered. In other embodiments, the detection is performed as a separate process independent of the determination of the focus.

The event may be an audio event (e.g., name or identity of a person spoken), a change for the shared content (e.g., new slide), or a change for the online conference itself (e.g., new attendee or text). For example, a new attendee joins, an attendee leaves, a new text message from another attendee or the presenter is received, and/or the shared content is annotated (e.g., highlighted, text altered, text deleted, text inserted, or a call-out box added). In another example, a switch or change in the shared content is detected. A new or different slide, page, application, or window is presented in the shared content. The presenter switching to a different slide is detected in one example. One or more different types of events are detected.

In one embodiment, the presenter switches their active window. For example, the presenter shares three windows in the desktop: outlook, chrome, and WebEx Connect. When the presenter switches from outlook to chrome as the active window, this event in the shared content is detected. In another embodiment, the presenter scrolls or alters the shared content partially. A difference in the content by a predetermined amount may be detected. The predetermined amount is configured by the attendee, the presenter, an administrator, and/or a programmer. Any amount of difference may be used to indicate that an event has been detected. For example, N % of change or amount of correlation is 50% (e.g., half the page is scrolled off of the shared content).

In yet another embodiment, a change to predetermined content is detected. For example, an attendee is interested in or expected to speak about shared content on a particular page of a presentation or document. By image processing at the location of page information in the program used to show the shared content (e.g., page box of WORD or ACROBAT or margins in a document or presentation), pattern matching may identify the page number. The attendee indicates the page or pages of interest. Once the shared content reaches the indicated page, an event is detected (e.g., when the presenter changes to page or slide 10, the event is detected). Other information than page number may be used, such as a picture, word, or subject matter.

In other embodiments, an audio event is detected. A mention of an identification of an attendee is detected. Using audio processing, the mention of a title, name, or other identifier is recognized by the computer of the attendee, conferencing server, or other computer. For example, the presenter is asking the attendee a question (e.g., “James, what do you . . . ?”). The computer of the attendee receives or creates the detection of the audio event.

Other events may be detected. The attendee, presenter, or others may select or determine which events are detected. A default or conference system group of events may be detected. Only one type of event may be searched for during the conference (e.g., only recognizing a change in a slide or page). Multiple different types of events may be searched for during the conference.

In act 26, the computer of the attendee notifies the attendee. The notification is generated by the computer of the attendee, or the notification is received from another source (e.g., conferencing server or computer of the presenter) and output by the computer of the attendee to notify.

The notification is in response to detecting of the event. When the event, representing a change in the online conference, is detected, the computer of the attendee responds by notifying the attendee. The notification occurs when the focus of the attendee is determined to be elsewhere and does not occur when the focus of the attendee is determined to be on the online conference. The determination of act 22 and the detection of act 24 are both pre-conditions to generating the notification. The notification is generated in response to detection of the event, which detection occurs due to monitoring triggered by determining that the focus of the attendee is on other information or program. For example, the notification is generated in response to an event where the online conference is inactive or at least partially not viewable. In other embodiments, only the detection of act 24 is used to trigger notification in act 26.

The notification is that there is an event or change in shared content. Alternatively or additionally, the notification includes an identity of the event and/or reference to the location of the change. The type of event may be identified.

Audio and/or visual notifications may be used. In one embodiment, the change or event is indicated by a display of the attendee. Any display on the screen of the attendee may be used. For example, an icon, window, and/or shared content is flashed (i.e., brightness varies). The flashing may occur once, continue until the online conference window is activated, or continue for a predetermined time. As another example, the window, shared content, or other online conference information or program is activated and/or maximized or expanded. Due to activation or other notification, the display for the online conference may be positioned in front of other programs so that all of the window or current shared content is visible without any obstruction from other programs or content. For example, the window of the online conference goes from being partially obstructed to not being obstructed in response to the detection of the event.

The type of notification used is set by the user, an administrator, the presenter, or predetermined by a programmer. The same type of notification is used for any event. Alternatively, different notifications are provided for different events. A pre-defined action is performed by the computer of the attendee for a type of event. For example, the event is switching a presentation slide to a new slide. The action notifying the attendee of this event is to maximize and activate the window of the online conference. Where the event is a new text message or change in attendees in the conference, an icon or window for the online conference is flashed or a textual notice identifying the change is temporarily displayed.

Since automated activation and/or maximization or expanding may be undesirable to some users, an alternative notification is generating a thumbnail. The thumbnail is a decreased size window relative to the expanded or regular view used by the attendee of the shared content. Alternatively, the thumbnail is less than ¼, less than 1/16, or less than 1/32 of the screen area. The thumbnail is created as a separate window. Alternatively, the thumbnail is graphically represented by a shrinking or expansion (e.g., from minimized) to the thumbnail window from the current window for the online conference.

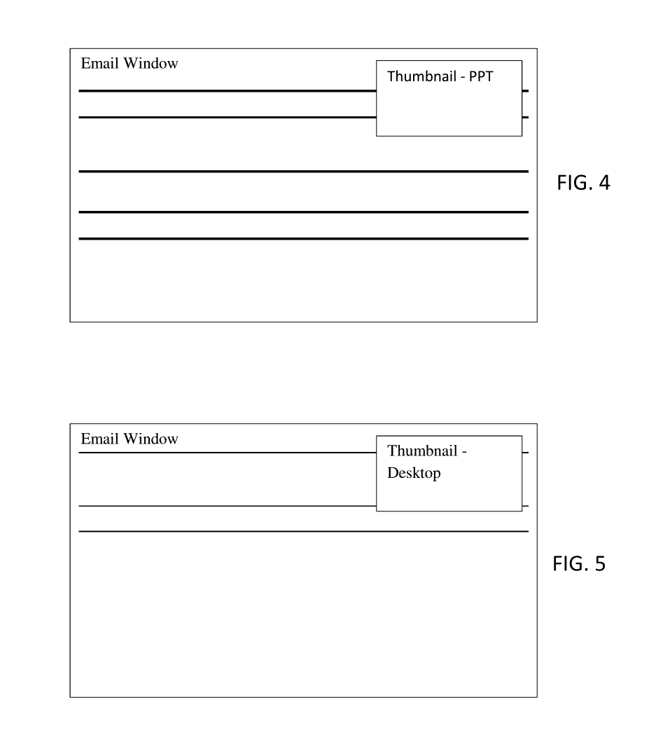

The thumbnail is always on top of the other content of the screen of the attendee. The thumbnail is unblocked by other information. FIG. 4 shows an example of a thumbnail. The thumbnail shows the shared content as a slide in a presentation. The thumbnail is shown on top of another program. In this case, the other program is a maximized email program. The window of the other program completely blocks the online conference window. In other examples, the other program only partially blocks the online conference window. The thumbnail may still be generated.

The thumbnail is generated for a limited amount of time. The display of the thumbnail is for a predetermined period, such as for 5-10 seconds. The thumbnail persists long enough to notify the attendee of the detected change or event and/or long enough for the attendee to see the new shared content. To avoid interference with the other program or other activity of the attendee, the thumbnail is removed or fades away after the end of the period. The event or ceasing of a detected event defines the beginning of the period of thumbnail persistence.

In one embodiment, the temporary display of the thumbnail as a notification is used for sharing a presentation (e.g., POWER POINT) or document (e.g., WORD or .pdf). Presentation and document sharing is common in online conferences. Due to the relatively static presentation of information as compared to video or streaming, the event of changing the shared content occurs infrequently. By notifying through a temporary thumbnail, the notification is less intrusive to the attendee. In alternative embodiments, the thumbnail is displayed continuously once triggered. Continuous display may be appropriate for more frequently changing content, such as a video.

In the example of FIG. 4, the presenter is sharing a POWER POINT presentation. The attendee is checking email during the online conference, having minimized and/or covered the online conference window, such as by maximizing the email window. When the presenter changes the slide or other change in the shared content occurs, the computer of the attendee detects the event and notifies the user by generating the thumbnail of the new slide or shared content. The thumbnail is displayed on top of the email and any other programs or windows. Once a period of display expires, the thumbnail is removed automatically.

The size, shape, color, and/or position of the thumbnail may be configured by the attendee, presenter, administrator, and/or programmer. The last, a default, or new configuration of the thumbnail is used. Once notified, the attendee may close the thumbnail before the time to remove expires. Once displayed, the attendee may modify the size of the thumbnail to be larger or smaller. Alternatively or additionally, the attendee may click on or double click the thumbnail to activate and place the online conference window on top of the screen (e.g., covering all or a portion of the email window in the example of FIG. 4).

The thumbnail is generated and presented to the attendee. Other computers of other attendees may not display thumbnails, such as due to the online conference window being active. In alternative embodiments, the conferencing server or the computer of the presenter generates a thumbnail when the change occurs and sends the thumbnail to the computers of the attendees for display if appropriate (i.e., different focus of the attendee).

In other embodiments, the thumbnail is generated for as long as the content is at least partially not viewable. Once triggered by detecting an event or triggered in response to a change in focus away from the online conference, the thumbnail is generated and persists until the online conference window is activated and/or positioned as the top program on the screen. For example, the presenter is sharing their entire desktop or multiple applications. FIG. 5 shows an example of sharing a desktop, as shown in the thumbnail, while the attendee is checking email. Such shared content may be streamed as a video. Other examples include a video conference where the image of the presenter is shared and updated in real-time (e.g., 5 or more frames per second). Due to the consistently changing content, the thumbnail is constantly displayed to the attendee. Alternatively, the thumbnail is displayed until an event becomes inactive (e.g., displayed as long as change over a given N % in a given period occurs). Once change or change by a sufficient difference no longer occurs, the thumbnail is automatically removed. If the event, such as a change in content, continues, then the thumbnail is displayed until another trigger is detected or until the attendee activates the shared content.

Where a portion of the online conferencing shared content or window is visible, even if inactive, the shared content may continue to be updated. As any change occurs, the change in the visible portion is altered to show the change. The computer of the attendee also creates the thumbnail when appropriate by decimating, filtering, or otherwise reducing the resolution of the shared content for the smaller thumbnail.

When the entire area for displaying shared content is covered (e.g., see FIG. 5 or minimization of the online conference window), only the thumbnail is provided to the attendee. In order to reduce bandwidth usage on the network or networks, a dynamic data acquisition mode for acquiring the shared content may be used. The shared content may be provided from the conferencing server at different resolutions—lower resolution for the thumbnail and higher resolution for the online conference window. Alternatively, the conferencing server continues to serve the shared content at a same resolution regardless of the type of display. The computer of the attendee reduces the resolution for display on the thumbnail image.

The different resolutions are preset or may be varied. For example, the lower resolution depends on the size of the thumbnail window. Using a predetermined or attendee set size, the size or a resolution for that size may be communicated to the conferencing server so that shared content at the appropriate resolution is provided to the computer of the attendee. Any time the thumbnail size changes, the resolution may be updated.

To vary the resolution of the shared data, the computer of the attendee requests and receives from the conferencing server the shared content at a resolution for the thumbnail. In this compression mode, the computer of the attendee no longer receives the original sharing data (shared content at full, regular, or standard resolution) from the conferencing server. The computer of the attendee sends a request to the conferencing server to get low-resolution (low quality) sharing data. Using the lower resolution shared content, the computer of the attendee renders the low resolution (low quality) sharing data in the thumbnail window and does not render any shared content in the completely obstructed online conference window.

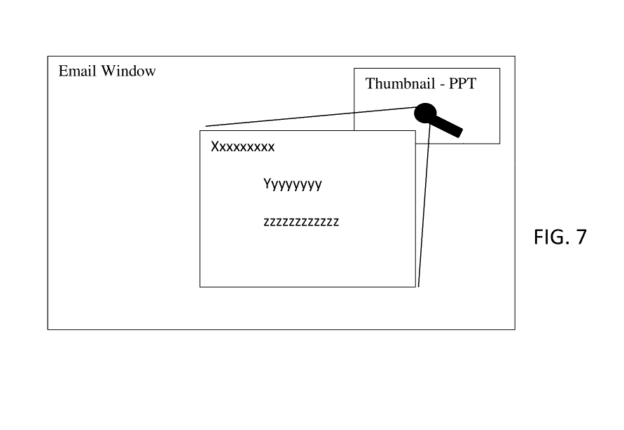

FIG. 7 shows an example embodiment of workflow for reducing bandwidth using the thumbnail display. In act 101, the host or computer of the presenter sends original sharing data to the conferencing server. In act 102, the conferencing server transfers the original sharing data to the computer of the attendee and other computers. The computer of the attendee receives the sharing data and renders the sharing data in an online meeting window. The process to this point may be repeated as the attendee views the conference in the online conferencing window.

The further acts occur when the attendee changes their focus, such as minimizing or covering all or a sufficiently large part of the online conferencing window. In act 103, a request is sent. An event is detected with the precondition indicating focus on something other than the conference. Where the compression mode is active or enabled, the computer of the attendee sends a request to the conferencing server. The request is that the conferencing server no longer sends original data to this attendee and instead sends low-resolution sharing data to this attendee. The request may indicate the size of the thumbnail, a resolution, and/or other information that may be used to determine the resolution to be sent. The resolution is based on the size of the thumbnail. Alternatively, the resolution is a default or predetermined regardless of the size of the thumbnail.

In act 104, the conferencing server receives the request and processes the request. The original or full resolution data is not longer to be sent to this attendee. The conferencing server extracts low-resolution sharing data based on any video algorithm, such as a compression, decimation, and/or filtering algorithm to reduce resolution. In act 105, the conferencing server sends low or lower resolution sharing data to the computer of the attendee. The computer of the attendee receives the low resolution sharing data and renders the shared content in the thumbnail. Since the online conference window is not visible, the shared content is not rendered in the online conference window. To keep the attendee informed of the shared content, the thumbnail is rendered on top of any other windows or programs.

Once the attendee activates or otherwise makes at least part or the entire online conference window visible and/or other event is detected, the computer of the attendee exits the compression mode. The computer of the attendee requests in act 106 that the conferencing server send original or greater resolution data instead of low resolution data. In act 107, the conferencing server processes the request and will no longer send low-resolution sharing data to this attendee, but instead sends original data. In act 108, the conferencing server sends original sharing data to the computer of the attendee. A direct mode using full resolution shared data is used. The shared content is rendered to the online conference window. The same data may or may not be used to render to the thumbnail, if the thumbnail continues to be displayed. Once the criterion or criteria for the thumbnail end (e.g., event is no longer met), the thumbnail may be hidden or no longer output.

In an extension of using the thumbnail to notify the attendee of events in the conference, the recognition of events may be used to provide other effects for the attendee. For example, when one of various events is triggered (detected), the thumbnail is generated. Further notification is provided by flashing, highlighting, or maximizing the thumbnail in response to that same or a further event.

Another extension is to add text. Since the thumbnail is small, a text description of the event (e.g., “host changed the active window” or “attendee XXXXX joined”) is provided on or near the thumbnail. The text may be provided at other locations.

In yet another extension, a magnifier capability is provided for any thumbnail. Since the thumbnail window is relatively small, a magnifier allows the attendee to view more detail without switching to the online meeting window or without resizing the thumbnail window. The attendee may position their cursor over the thumbnail or otherwise indicate a location of magnification. Activation of the magnification, such as depressing the “m” key, may or may not be required. A magnified version of the shared content at that location is displayed in response. FIG. 7 shows an example. The cursor is represented as a magnifying glass. A larger thumbnail is shown with the magnified, relative to the thumbnail, shared content being shown. In alternative embodiments, the magnified shared content is shown in the thumbnail, replacing other content.

Where the shared content is received in full resolution from the conferencing server, the computer of the attendee creates the magnified content. The computer reuses local cached sharing data. If the current data content of the thumbnail is in the compression mode, then the shared content for magnification is not available locally. The computer of the attendee requests and receives, from the conferencing server, the shared content at a greater resolution in response to activation of the magnifier. The magnified content is shown at the original or full resolution or a lower resolution that is greater than the thumbnail resolution. The request is for receiving the original shared content that may be reduced in resolution by the computer of the attendee or for receiving greater resolution but not original resolution shared content appropriate for the magnification.

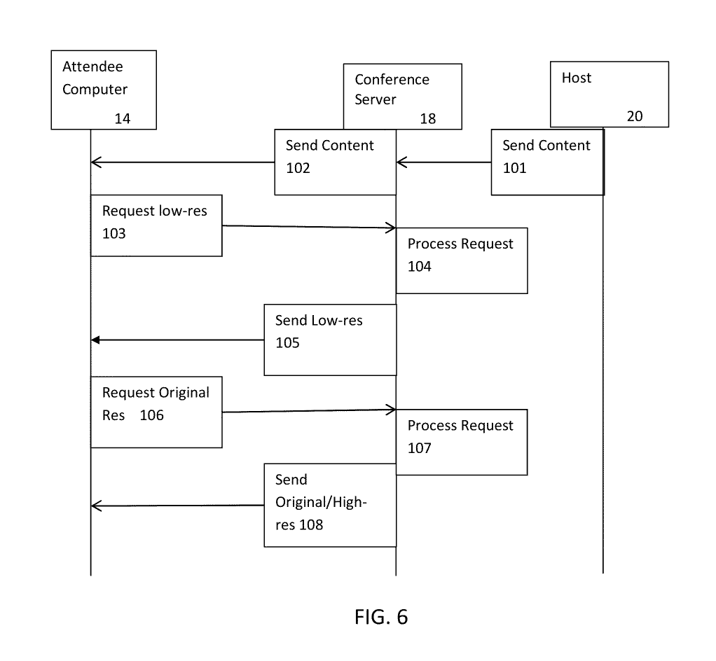

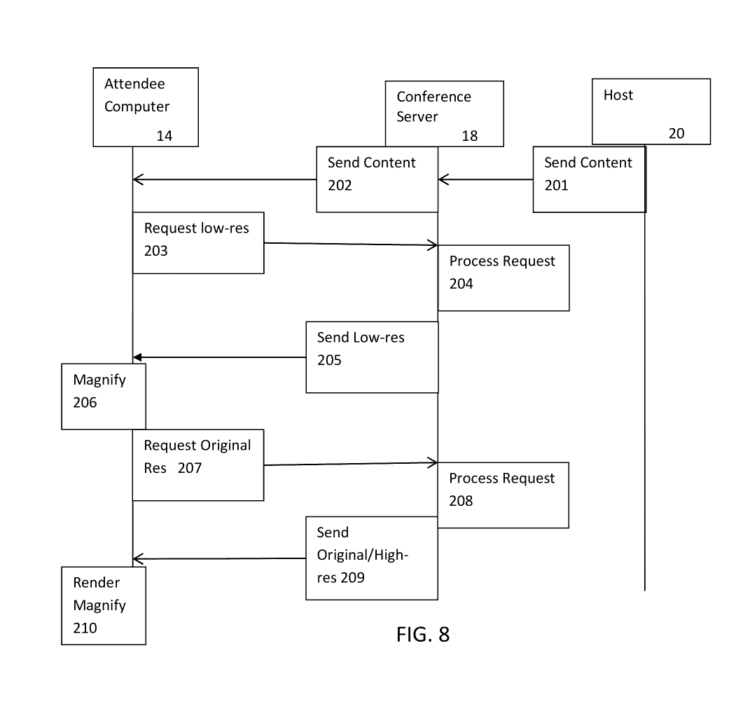

FIG. 8 shows an example embodiment workflow for reducing bandwidth using the thumbnail display until magnification occurs. Acts 201-205 correspond to acts 101-105 of FIG. 6, so are not detailed again. In act 206, the cursor is hovered or moved onto the thumbnail image. A mouse, track ball, trackpad or other user input is used by the attendee seeking higher resolution information about the shared content of the thumbnail. In response, the computer of the attendee requests the shared content at the original resolution from the conferencing server in act 207. In act 208, the conferencing server processes the request. The resolution of the shared content to be sent to the computer of the attendee is switched from the compressed or lower resolution data for the thumbnail to the original resolution of the shared content. In act 209, the conferencing server sends the original or high resolution data. In act 210, the computer of the attendee renders the magnified shared content. The shared content may be decimated or reduced in resolution by the computer of the attendee for continued display of the thumbnail during magnification. Video technology is used by the computer so that the thumbnail appears to be the same resolution as provided when the conferencing server sends the low resolution shared content. Using the workflow of FIG. 8 dynamically switches data quality from low quality data to original quality (or higher quality) data. Other workflows and/or communications schemes may be used.

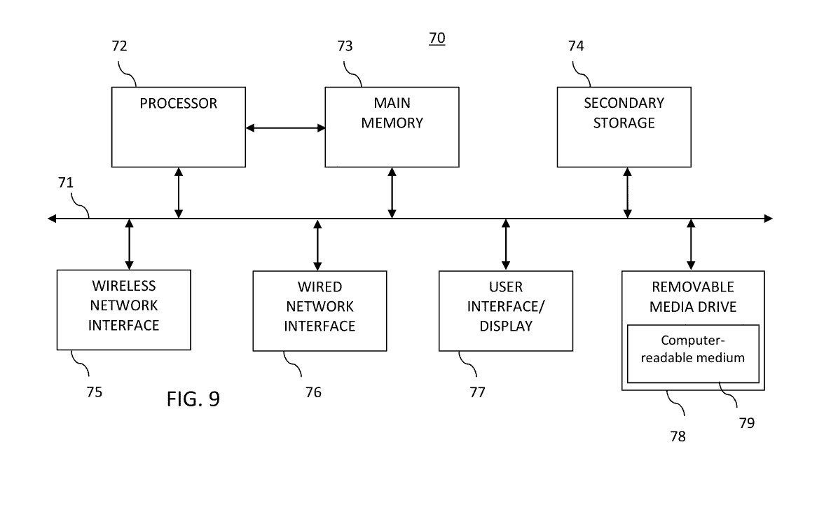

FIG. 9 is one embodiment of an apparatus for notification about a change in hidden content in online conferencing. The apparatus is shown as a simplified block diagram of an example network device, such as the end-point device 14, 20, 22, or conferencing server 18 of FIG. 1. In FIG. 9, the example network apparatus or device 70 corresponds to network elements or computing devices that may be deployed in the conferencing network 10. The network device 70 includes software and/or hardware to perform any one or more of the activities or operations for determining, detecting, requesting, transmitting, receiving, and/or displaying for notification to an attendee.

The network device 70 includes a processor 72, a main memory 73, secondary storage 74, a wireless network interface 75, a wired network interface 76, a user interface (e.g., user input and display devices) 77, and a removable media drive 78 including a computer-readable medium 79. A bus 71, such as a system bus and a memory bus, may provide electronic communication between processor 72 and the other components, memory, drives, and interfaces of network device 70.

Additional, different, or fewer components may be provided. The components are intended for illustrative purposes and are not meant to imply architectural limitations of network devices. For example, the network device 70 may include another processor and/or not include the secondary storage 74 or removable media drive 78. As another example, the network device 70 connects with a camera, speaker, and/or microphone. Each network device may include more or less components than other network devices.

The network device 70 is personal computer, tablet, smart phone, server, network processor, or other computer. In one embodiment, the network device 70 is a conferencing server or user computer (e.g., personal computer, laptop, smart phone, tablet, or mobile device) with conferencing capability or software. The network device 70 may be a computer with web browsing software where the web browser displays the conferencing information from a server.

In one embodiment, the network device 70 is part of a conferencing system, such as a telepresence system (from Cisco), WebEx system (from Cisco) or other online conference system. Any device for participating, hosting, and/or controlling online conferencing may be used.

Instructions embodying the activities or functions described herein may be stored on one or more external computer-readable media 79, in main memory 73, in the secondary storage 74, or in the cache memory of processor 72 of the network device 70. These memory elements of network device 70 are non-transitory computer-readable media. The logic for implementing the processes, methods and/or techniques discussed herein are provided on non-transitory computer-readable storage media or memories, such as a cache, buffer, RAM, removable media, hard drive or other computer readable storage media. Computer readable storage media include various types of volatile and nonvolatile storage media. Thus, ‘computer-readable medium’ is meant to include any medium that is capable of storing instructions for execution by network device 70 that cause the machine to perform any one or more of the activities disclosed herein. The instructions are logic for performing the acts.

The instructions stored on the memory as logic may be executed by the processor 72. The functions, acts or tasks illustrated in the figures or described herein are executed in response to one or more sets of instructions stored in or on computer readable storage media. The logic of the functions, acts or tasks are independent of the particular type of instructions set, storage media, processor or processing strategy and may be performed by software, hardware, integrated circuits, firmware, micro code and the like, operating alone or in combination. Likewise, processing strategies may include multiprocessing, multitasking, parallel processing and the like.

The memory (e.g., external computer-readable media 79, in main memory 73, in the secondary storage 74, or in the cache memory of processor 72) also stores shared content, configuration of notifications, event lists, active status, visibility information, pointer location, foreground status, and/or interaction information.

The wireless and wired network interfaces 75 and 76 may be provided to enable electronic communication between the network device 70 and other network devices via one or more networks. In one example, the wireless network interface 75 includes a wireless network interface controller (WNIC) with suitable transmitting and receiving components, such as transceivers, for wirelessly communicating within the network 10. In another example, the wireless network interface 75 is a cellular communications interface. The wired network interface 76 may enable the network device 70 to physically connect to the network 10 by a wire, such as an Ethernet cable. Both wireless and wired network interfaces 75 and 76 may be configured to facilitate communications using suitable communication protocols, such as the Internet Protocol Suite (TCP/IP).

The network device 70 is shown with both wireless and wired network interfaces 75 and 76 for illustrative purposes only. While one or both wireless and hardwire interfaces may be provided in the network device 70, or externally connected to network device 70, only one connection option is needed to enable connection of network device 70 to the network 10. The network device 70 may include any number of ports using any type of connection option.

The network interfaces 75 and/or 76 may be configured to transmit audio, video, requests, responses, detections, determinations, and/or shared content for online conferences. In one embodiment, the network interfaces 75 and/or 76 are configured to transmit shared content to participants, such as attendees, of an online conference. Updated shared content or content reflecting changes by a presenter or attendee may be transmitted to the participants. The shared content may be transmitted at various resolutions. Other conference information, such as participant information and texts, may be transmitted.

Additionally or alternatively, the network interfaces 75 and/or 76 may be configured to receive audio, video, requests, responses, detections, determinations, and/or shared content for online conferences. In one embodiment, the network interfaces 75 and/or 76 are configured to receive shared content and other conference information from a conferencing server and/or computer of a presenter. The shared content may be received as a video stream at lower or higher resolutions or as more static document or presentation information.

The processor 72, which may also be a central processing unit (CPU), is any general or special-purpose processor capable of executing machine readable instructions and performing operations on data as instructed by the machine readable instructions. The main memory 73 or other memory may be accessible to processor 72 for accessing machine instructions and may be in the form of random access memory (RAM) or any type of dynamic storage (e.g., dynamic random access memory (DRAM)). The secondary storage 74 may be any non-volatile memory, such as a hard disk, which is capable of storing electronic data including executable software files. Externally stored electronic data may be provided to computer 70 through one or more removable media drives 78, which may be configured to receive any type of external media 79, such as compact discs (CDs), digital video discs (DVDs), flash drives, external hard drives, or any other external media.

The processor 72 is configured by the instructions and/or hardware to control a user interface, such as running an operating system. The active status of different windows and/or programs is managed as well as the display of information for the windows and/or programs. The processor 72 is configured to display shared content for an online conference. The processor 72 is configured to determine whether the window or other display for the online conference is inactive and/or at least partially obstructed on the screen. Using the received shared content or notices from another source, the processor 72 is configured to detect a change or event in the online conference, such as detecting switching of slides, scrolling of a document, joining or leaving of a participant, a new text message, annotation, audio mention of an identity, or selection of a different application. In response, the processor 72 is configured to notify the attendee of detection, of what is detected, or other information.

In one embodiment, the processor 72 is configured to notify by presenting a thumbnail when the shared content is partially or wholly covered by other programs or windows. Where higher resolution information is not needed (e.g., wholly covered shared content window), the processor 72 is configured to request and receive a video stream or other shared content of the online conference at the lower resolution. The request is in response to a user activating a program different than the online meeting or minimizing the online meeting. The processor 72 receives the lower resolution shared content to generate a thumbnail of the video for the display of the video at the lower resolution. When the online meeting is in an active window, the processor 72 receives the video stream at a higher resolution, and when the online meeting is in an inactive window or minimized, the processor 72 receives the video stream at a lower resolution.

The processor 72 is configured to generate a graphic, image, or other display to notify the user of the event in the online meeting. The notification is output to the user interface 77 for display to the attendee.

The user interface 77 includes a display device (e.g., plasma display panel (PDP), a liquid crystal display (LCD), or a cathode ray tube (CRT)). The display of the user interface 77 is configured by output by the processor 72 and/or a video card. Software and/or hardware are used to configure the display to show a desktop, windows, notifications, thumbnails, or other information. In one embodiment, the display is configured to display video from the video stream at the lower resolution of a thumbnail in response to the user activating a program different than the online meeting. The display the video at the lower resolution is shown on top of other content of the display.

In addition, the user interface 77 may include any appropriate input device, such as a keyboard, a touch screen, a mouse, a trackball, microphone (e.g., input for audio), camera, buttons, and/or touch pad. In other embodiments, only the display (e.g., touch screen) is provided.

Additional hardware may be coupled to the processor 72 of the network device 70. For example, memory management units (MMU), additional symmetric multiprocessing (SMP) elements, physical memory, peripheral component interconnect (PCI) bus and corresponding bridges, or small computer system interface (SCSI)/integrated drive electronics (IDE) elements. The network device 70 may include any additional suitable hardware, software, components, modules, interfaces, or objects that facilitate operation. This may be inclusive of appropriate algorithms and communication protocols that allow for the effective protection and communication of data. Furthermore, any suitable operating system is configured in network device 70 to appropriately manage the operation of the hardware components therein.

While the invention has been described above by reference to various embodiments, it should be understood that many changes and modifications can be made without departing from the scope of the invention. It is therefore intended that the foregoing detailed description be regarded as illustrative rather than limiting, and that it be understood that it is the following claims, including all equivalents, that are intended to define the spirit and scope of this invention.

What is claimed is:

1. A method comprising:
presenting content from a screen of a presenter in an online conference on a screen of an attendee;
determining, by a computer of the attendee, that the content on the screen of the attendee is inactive or at least partially not viewable;
detecting an event in the online conference; and
notifying, by the computer, the attendee in response to the detecting of the event where the content is determined to be inactive or at least partially not viewable.

2. The method of claim 1 wherein presenting the content comprises sharing a desktop or application of the presenter from a computer of the presenter.

3. The method of claim 1 wherein presenting the content comprises sharing a document or presentation of the presenter from a computer of the presenter.

4. The method of claim 1 wherein determining comprises determining that a window for displaying the content of the online conference is inactive or minimized.

5. The method of claim 1 wherein determining comprises determining that a window for displaying the content of the online conference is covered by a window of another application by at least a predetermined amount or totally covered on the screen of the attendee.

6. The method of claim 1 wherein detecting comprises detecting joining of a new attendee, a new text message, and/or annotation of the content.

7. The method of claim 1 wherein detecting comprises detecting switching of the content to a new slide or new window of the presenter.

8. The method of claim 1 wherein detecting comprises detecting a difference in the content by a predetermined amount.

9. The method of claim 1 wherein detecting comprises detecting a change in the content to predetermined content.

10. The method of claim 1 wherein detecting comprises detecting a mention of an identification of the attendee.

11. The method of claim 1 wherein notifying comprises, on the screen of the attendee, flashing a window or icon of the online conference, activating the window of the online conference, maximizing the window of the online conference, or changing to display of all of the window of the online conference.

12. The method of claim 1 wherein notifying comprises generating a thumbnail unblocked by other information on the screen of the attendee, the thumbnail generated for a predetermined amount of time in response to the detecting of the event.

13. The method of claim 1 wherein notifying comprises generating a thumbnail unblocked by other information on the screen of the attendee, the thumbnail generated for as long as the content is at least partially not viewable.

14. The method of claim 1 wherein notifying comprises generating a thumbnail unblocked by other information on the screen of the attendee, and wherein determining comprises determining that the content is entirely not viewable; and
further comprising requesting and receiving, from a conferencing server, the content at a resolution for the thumbnail.

15. The method of claim 14 further comprising requesting and receiving, from the conferencing server, the content at a greater resolution in response to positioning a cursor over the thumbnail.

16. Logic encoded in one or more non-transitory computer-readable media that includes code for execution and when executed by a processor is operable to perform operations comprising:
recognizing a change in shared content of an online meeting where an attendee's active application is other than the online meeting; and
indicating the change by a display to the attendee.

17. The logic of claim 16 wherein recognizing comprises recognizing switching to a new slide, new page, or new application, and wherein indicating comprises displaying the shared content as changed in a region that is less than ¼ of a screen, the displaying being limited to a predetermined period.

18. An arrangement comprising:
an interface configured to receive a video stream at lower and higher resolutions as part of an online meeting;
a processor configured to request and receive the video stream at the lower resolution in response to a user activating a program different than the online meeting or minimizing the online meeting; and
a display configured to display video from the video stream at the lower resolution in response to the user activating the program different than the online meeting.

19. The arrangement of claim 18 wherein the processor is configured to receive the video stream at the higher resolution when the online meeting is in an active window and receive the video stream at the lower resolution when the online meeting is in an inactive window or minimized, and wherein the display is configured to display the video at the lower resolution on top of content of the display.

20. The arrangement of claim 18 wherein the processor is configured to generate a thumbnail of the video for the display of the video at the lower resolution.
